(19) United States
(12) Patent Application Publication
(10) Pub. No.: US 2026/0016591 A1
(43) Pub. Date: Jan. 15, 2026

(54) DISTANCE MEASUREMENT SYSTEM AND DISTANCEMEASUREMENT METHOD

(71) Applicant: DENSO CORPORATION, Kariya-city (JP)

(72) Inventor: Yuji MORI, Kariya-city (JP)

(21) Appl. No.: 19/338,558

(22) Filed: Sep. 24, 2025

Related U.S. Application Data
(63) Continuation of application No. PCT/JP2024/012213, filed on Mar. 24, 2024.

(30) Foreign Application Priority Data
Apr. 5, 2023 (JP) 2023-0611691

(51) Int. Cl. G01S 13/76; G01S 13/02; H04W 64/00

(52) U.S. Cl. CPC G01S 13/765; G01S 13/0209; H04W 64/00

(57) ABSTRACT

A distance measurement system includes: a communication unit configured to perform distance measurement communication with a plurality of mobile devices; and a control device including a storage that stores information of the plurality of mobile devices. The control device is configured to prioritize the plurality of mobile devices, and notify the communication unit of a priority of each mobile device. The communication unit or the control device is configured to acquire a distance measurement timing, and determine whether a collision timing is present at which the distance measurement timing overlaps. The communication unit is configured to perform the distance measurement communication with a high priority device in a state where the distance measurement timing overlaps at the collision timing.

### CROSS REFERENCE TO RELATED APPLICATIONS

The present application is a continuation application of International Patent Application No. PCT/JP2024/012213 filed on Mar. 27, 2024, which designated the U.S. and claims the benefit of priority from Japanese Patent Application No. 2023-061691 filed on Apr. 5, 2023. The entire disclosures of all of the above applications are incorporated herein by reference.

### TECHNICAL FIELD

The present disclosure relates to a technology for wirelessly measuring a distance from a predetermined reference point to a mobile device.

### BACKGROUND

A system for determining a position of a mobile device with respect to a vehicle by performing distance measurement communication using ultra wide band (UWB) communication with the mobile device has been known as a comparative example. In a configuration of the comparative example, a setting parameter (for example, distance measurement interval) for distance measurement communication by the UWB is exchanged using Bluetooth (registered trademark) communication before distance measurement communication by the UWB. The distance measurement communication between the vehicle and the mobile device may be periodically performed in accordance with agreed setting parameters.

### SUMMARY

According to an aspect of the present disclosure, a distance measurement system includes: a communication unit configured to perform distance measurement communication with a plurality of mobile devices; and a control device including a storage that stores information of the plurality of mobile devices. The control device is configured to prioritize the plurality of mobile devices, and notify the communication unit of a priority of each mobile device. The communication unit or the control device is configured to acquire a distance measurement timing, and determine whether a collision timing is present at which the distance measurement timing overlaps. The communication unit is configured to perform the distance measurement communication with a high priority device in a state where the distance measurement timing overlaps at the collision timing.

### BRIEF DESCRIPTION OF THE DRAWINGS

FIG. 1 is a diagram showing an overall view of a vehicle electronic key system.

FIG. 2 is a block diagram showing a configuration of an in-vehicle system.

FIG. 3 is a block diagram showing a configuration of a mobile device.

FIG. 4 is a diagram showing a mounting position of an anchor.

FIG. 5 is a block diagram showing a configuration of an anchor.

FIG. 6 is a sequence diagram showing a flow of distance measurement communication between the mobile device and a vehicle.

FIG. 7 is a diagram for illustrating a distance calculation method.

FIG. 8 is a diagram for illustrating an execution timing of the distance measurement communication.

FIG. 9 is a sequence diagram showing an operation of the entire system from a communication connection to a start of distance measurement communication.

FIG. 10 is a diagram showing a distance measurement timing in a collision case.

FIG. 11 is a flowchart for illustrating a flow of the entire system.

FIG. 12 is a flowchart of a priority determination process.

FIG. 13 is a flowchart of a collision determination process.

FIG. 14 is a diagram for illustrating an operation of an anchor when a collision of distance measurement communication occurs.

FIG. 15 is a flowchart for illustrating another example of operation of the in-vehicle system when the collision occurs.

FIG. 16 is a diagram for illustrating a configuration for determining an effective priority determined based on a registered priority and a reception strength of a short range communication signal.

FIG. 17 is a diagram showing another example of an arrangement of anchors.

### DETAILED DESCRIPTION

When multiple registered devices exist in the vicinity of the vehicle at the same time, the in-vehicle UWB module performs distance measurement communication with each of the multiple mobile devices. Since the distance measurement communication with each of the multiple mobile devices is periodically executed, the timing of the distance measurement communication with any two mobile devices may overlap. On the other hand, the UWB module can perform the distance measurement communication with only one mobile device at the completely same timing. In a case where the timings of distance measurement communication with multiple devices overlap, when the distance measurement with the mobile device possessed by the user with the low intention to use the vehicle is prioritized, detection of the approach of the user who is truly intended to use the vehicle is delayed. As a result, the convenience for the user may be reduced.

In response to such a difficulty, in the comparative example, a situation where the UWB module of the vehicle measures and communicates with each of the multiple mobile devices in parallel is not assumed. Naturally, a response strategy when timings of distance measurement communication with multiple devices overlap has not been considered.

An example of the present disclosure provides a technology capable of reducing delays of detection in response to user approaches.

According to an example embodiment of the present disclosure, a distance measurement system includes: a communication unit configured to perform distance measurement communication with multiple mobile devices using a predetermined wireless protocol; and a control device including a storage that stores information of the multiple mobile devices that are a position determination target. The control device is configured to prioritize the multiple mobile devices, and notify the communication unit of a priority of each mobile device. The communication unit or the control device is configured to acquire a distance measurement timing that is a timing for performing the distance measurement communication with the multiple mobile devices, and determine whether a collision timing is present at which the distance measurement timing of the multiple mobile devices overlaps. The communication unit is configured to perform the distance measurement communication with a high priority device. The high priority device is a mobile device having a higher priority than a priority of a different mobile device among the multiple mobile devices in a state where the distance measurement timing overlaps at the collision timing.

In the distance measurement system described above, distance measurement communication with the mobile device having the high priority is preferentially executed at the collision timing. Therefore, according to the distance measurement system described above, it is possible to reduce the detection delay due to the approach of the user of the mobile device whose priority is set to be relatively high to the vehicle.

According to another example embodiment of the present disclosure, a distance measurement method includes: causing a control device to store information of multiple mobile devices that are a position determination target in a storage; causing the control device to prioritize the multiple mobile devices for which information is stored in the storage; causing the control device to notify a communication unit, configured to perform distance measurement communication with the multiple mobile devices using a predetermined wireless protocol, of a priority of each mobile device; causing a communication unit or a control device to identify a distance measurement timing that is an execution timing of the distance measurement communication for each mobile device; causing the communication unit or the control device to determine whether a collision timing is present at which the distance measurement timing of the multiple mobile devices overlaps; and causing the communication unit to perform the distance measurement communication with a high priority device. The high priority device is a mobile device having a higher priority than a priority of a different mobile device among the multiple mobile devices in a state where the distance measurement timing overlaps at the collision timing.

Hereinafter, an embodiment of the present disclosure will be described below with reference to the drawings. The present disclosure is not limited to the following embodiment, and various modifications can be made without departing from the scope of the gist. The various modifications described below may be implemented in any suitable combination as long as no technical contradiction occurs. The present disclosure also includes a configuration that does not explicitly include a combination of multiple modifications. In the following description, the same reference numerals are used for components having the same function, and their specific descriptions may be omitted. Further, when only a part of the configuration is mentioned, the above description can be applied to the other parts.

### Overall Configuration

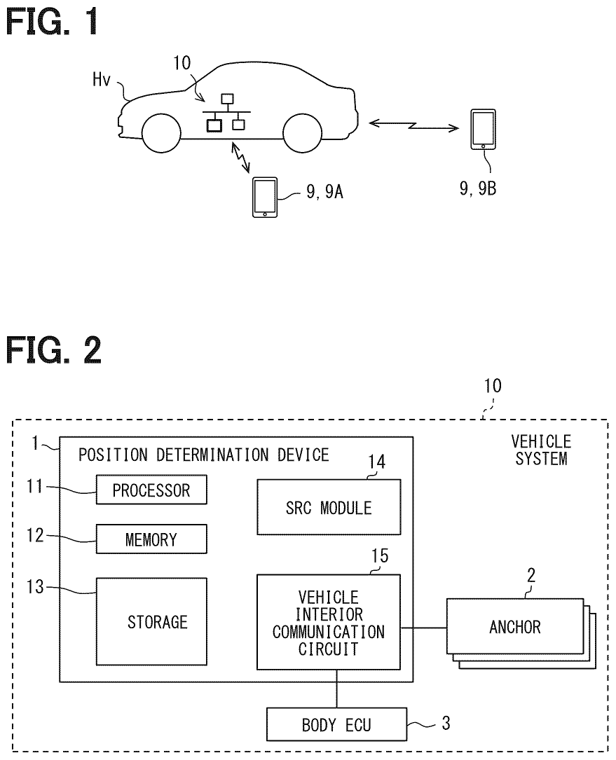

As shown in FIG. 1, an electronic key system for a vehicle according to the present embodiment includes an in-vehicle system 10 and one or more mobile devices 9. The in-vehicle system 10 is a system mounted on a vehicle Hv. As shown in FIG. 2, the in-vehicle system 10 includes a position determination device 1 and multiple anchors (also referred to as anchor nodes) 2. The in-vehicle system 10 corresponds to a distance measurement system. Further, a method executed by the distance measurement system corresponds to a distance measurement method.

The mobile device 9 is a wireless communication terminal carried by each of multiple users. The mobile device 9 is associated with the position determination device 1. The device associated with the position determination device 1 refers to a device whose device information is registered in the position determination device 1. The device information includes an identification number (hereinafter, device ID) of the device. The device ID is different for each mobile device 9. The device ID may be a device address, a universally unique identifier (UID), or the like. Hereinafter, a case where the two mobile devices 9a and 9b are associated with the position determination device 1 will be described. When the mobile devices 9a and 9b are not distinguished, they are simply referred to as the mobile device 9. The user of the mobile device 9a is also referred to as a first user, and the user of the mobile device 9b is also referred to as a second user. The number of mobile devices 9 associated with the position determination device 1 may be three or more.

The position determination device 1 is a device that determines the position of the mobile device 9 with respect to the vehicle Hv. The position determination device 1 and the multiple mobile devices 9 each include a short range communication module. The short range communication module is a wireless communication module for performing short range communication. Here, the short range communication refers to communication conforming to a predetermined wireless communication standard in which a substantial communicable distance is about 5 meters (m) to 50 meters and a maximum communicable distance is about 100 m. The short range communication may be Bluetooth (registered trademark) Low Energy (hereinafter referred to as Bluetooth LE), Wi-Fi (registered trademark), or the like. In the following descriptions and the drawings, the short range communication may be referred to as SRC (Short Range Communication) or SRWC (Short Range Wireless Communication). Hereinafter, the signal transmitted and received by the short range communication may be also referred to as a short range communication signal or an SRC signal.

Hereinafter, the operation of each part will be described as an example in which the short range communication is Bluetooth LE. Furthermore, hereinafter, the mobile device 9 is set to act as a central (master) in Bluetooth LE, and the position determination device 1 is set to act as a peripheral (slave). Of course, the roles of the mobile device 9 and the position determination device 1 may be switched.

The anchor 2 is a wireless communication module for performing distance measurement communication with the mobile device 9 described later. The distance measurement communication may be performed by UWB communication, which is an UWB-IR (Ultra Wide Band-Impulse Radio) type wireless communication. Each of the multiple anchors 2 and the multiple mobile devices 9 of the present embodiment can perform the UWB communication. That is, the anchor 2 and the mobile device 9 are capable of transmitting and receiving impulse-shaped radio waves (hereinafter, impulse signals) used in UWB communication. The impulse signal used in UWB communication may be a signal with an extremely short pulse width (for example, 2 ns) and a bandwidth (that is, the ultra-wide bandwidth) of 500 MHZ (strictly speaking, 499.2 MHZ) or greater. Hereinafter, the UWB signal means a signal exchanged in the UWB communication. The anchor 2 corresponds to a communication unit capable of distance measurement communication.

### Mobile Device

The mobile device 9 may be a mobile information processing terminal having a short range communication function. The mobile device 9 may be any of a variety of communication terminals, such as a smartphone or a wearable device. The mobile device 9 can also be called a user device or a key device.

The mobile device 9 may be a smart key that is a dedicated device serving as an electronic key of the vehicle Hv. The smart key is a device that is transferred to the owner together with the vehicle Hv when the vehicle Hv is purchased. The smart key can be regarded as one of accessories of the vehicle Hv. The smart key may have various shapes such as a flat rectangular parallelepiped shape, a flat elliptical shape (so-called fob type), and a card shape. The smart key may be referred to as a vehicle mobile device, a key fob, a key card, an access key, or the like. The mobile device 9 may be a device that functions as a key of the vehicle Hv by performing wireless authentication using short range communication with the position determination device 1.

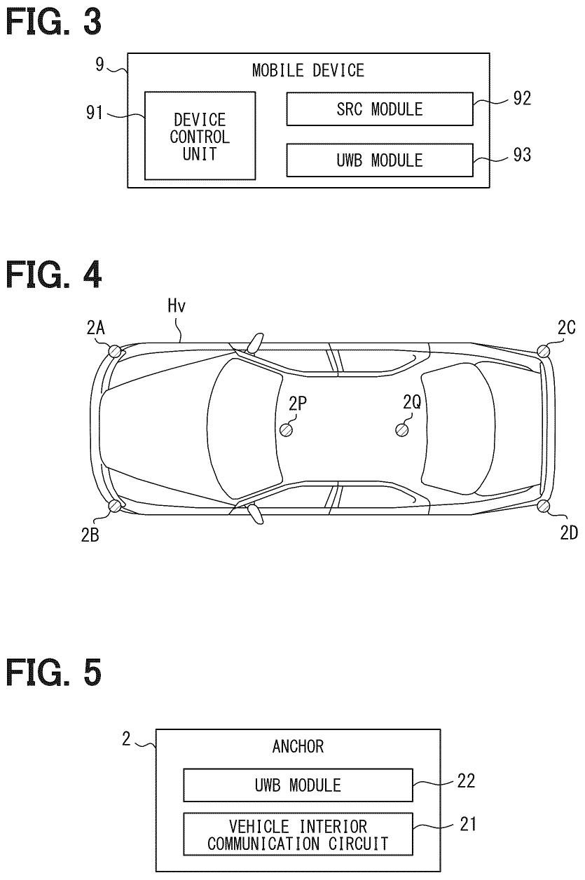

As shown in FIG. 3, the mobile device 9 includes a device control unit 91, a short range communication module 92, and an UWB module 93. The device control unit 91 is a module that controls an entire operation of the mobile device 9. The device control unit 91 may be implemented by a computer, which includes a device processor, a memory, a storage, and an input output circuit. The device processor executes various calculation processes. The device processor may be, for example, a CPU (Central Processing Unit). The memory is a volatile storage medium such as RAM (Random Access Memory). The storage is a storage device including a nonvolatile storage medium such as a flash memory.

The storage stores the device ID of the mobile device 9 and various data for wirelessly communicating with the position determination device 1. The data for wirelessly communicating with the position determination device 1 includes a parameter received from the position determination device 1 by pairing, such as a device ID of the position determination device 1. Further, the data for wirelessly communicating with the position determination device 1 may include an identification number (hereinafter, vehicle ID) of the vehicle Hv. The vehicle ID corresponds to identification information of the vehicle/in-vehicle system to be communicated. The vehicle ID may be rephrased as a system ID. The vehicle ID may be a VIN (Vehicle Identification Number) or a different type of number from the VIN. The vehicle ID may be a global identification number assigned by a predetermined rule.

The storage may store the key code used for wireless authentication with the position determination device 1. The key code may also be called an encryption key. A digital key app, which is an application software for causing the mobile device 9 to function as an electronic key for the vehicle Hv, may be installed in the storage. The digital key application is an application for secure communication with the position determination device 1 and safe storage of data related to the use of the vehicle Hv. The app is an abbreviation for application software.

The short range communication module 92 is a short range communication module included in the mobile device 9. The configuration and function of the short range communication module 92 may be similar to a short range communication module 14 of the position determination device 1 described later. Hereinafter, when the short range communication module 92 of the mobile device 9 and the short range communication module 14 of the position determination device 1 are not distinguished, they will also be (merely) referred to as short range communication modules without reference.

The UWB module 93 is a communication module for performing UWB communication. The UWB module 93 outputs the reception data to the device control unit 91. Further, the UWB module 93 transmits the UWB signal corresponding to the transmission data based on an instruction from the device control unit 91. The operation of the UWB module 93 is controlled by the device control unit 91. Hereinafter, when the UWB module 93 of the mobile device 9 and an UWB module 22 of the position determination device 1 are not distinguished, they will also be simply referred to as UWB modules.

The device control unit 91 periodically scans the short range communication module 92 and attempts to connect to the position determination device 1. When the short range communication module 92 receives an advertisement signal (for example, ADV_IND) from the position determination device 1, the device control unit 91 transmits a connection request signal (for example, CONNECT_IND) to the position determination device 1, and communicates with the position determination device 1.

When the communication connection with the position determination device 1 is completed, the device control unit 91 exchanges the parameter (hereinafter, distance measurement setting) for distance measurement communication by short range communication. Then, the device control unit 91 causes the UWB module 93 to perform distance measurement communication with each anchor 2 in a mode according to the distance measurement setting. A specific procedure of the distance measurement communication will be described later.

The device control unit 91 may cause the UWB module 93 to sleep when it is not connected to the position determination device 1 by short range communication. The sleep state of the UWB module 93 may be a state in which some or all functions are stopped in order to reduce power consumption. The device control unit 91 may transition the UWB module 93 to the active state based on connection with the position determination device 1 via short range communication. The active state is a state where the UWB signal can be transmitted and received. This control can reduce the power consumption during standby. In addition, the device control unit 91 may execute an authentication process (that is, wireless authentication) by short range communication based on the establishment of a communication connection with the position determination device 1. The wireless authentication may be performed by a challenge-response method.

### In-vehicle System

As shown in FIG. 2, the in-vehicle system 10 may include other devices such as a body ECU 3 in addition to the position determination device 1 and the multiple anchors 2. The position determination device 1 is connected to each of the multiple anchors 2 by a dedicated communication cable. The position determination device 1 is connected to the body ECU 3 via a vehicle interior network. The vehicle interior network is a communication network constructed in the vehicle Hv. As the standard of the vehicle interior network, various standards such as Controller Area Network (CAN, registered trademark), Ethernet (registered trademark), FlexRay (registered trademark), and the like can be adopted. The connection form between the devices disclosed here is an example and may be changed as appropriate. The position determination device 1 and the multiple anchors 2 may be connected via the vehicle interior network.

The position determination device 1 is an ECU that determines the device position in cooperation with the anchor 2. In the present disclosure, the device position refers to the relative position of the mobile device 9 with respect to the vehicle Hv. Since the mobile device 9 corresponds to the user, determining the device position corresponds to determining the position of the user. Therefore, the description of the device position may be read as a user position. The position determination device 1 controls the operation of the anchor 2.

The position determination device 1 includes a processor 11, a memory 12, a storage 13, the short range communication module 14, and a vehicle interior communication unit 15. The processor 11 may be a CPU. The memory 12 may be a volatile storage medium (for example, a RAM). The storage 13 includes a non-volatile storage medium such as a flash memory. The storage 13 may include multiple types of storage media such as ROM (Read Only Memory) and flash memory. The position determination device 1/processor 11 corresponds to a control device.

The storage 13 stores a position determination program. The position determination program is a program including instructions for causing a computer to function as the position determination device 1. The position determination program is executed by the processor 11. Execution of the position determination program by the processor 11 corresponds to execution of the position determination method corresponding to the position determination program. The position determination method includes some or all of the distance measurement methods. Further, the storage 13 may store data indicating the device ID of the mobile device 9, the mounting position of each anchor 2 at the vehicle Hv, and data (for example, key code) for authenticating the mobile device 9.

The short range communication module 14 is a short range communication module built into the position determination device 1. The short range communication module 14 receives the power of the in-vehicle battery even while the traveling power source is set to off. The short range communication module 14 periodically advertises using power supplied from the in-vehicle battery and attempts to connect to the mobile device 9. The advertisement is a process of transmitting an advertisement signal using a predetermined channel. The advertisement signal is a wireless signal for providing notification of (that is, advertising) the presence to another device. When the short range communication module 14 receives the connection request signal from the mobile device 9, it communicates with the mobile device 9.

The vehicle interior communication unit 15 is a circuit for the processor 11 to communicate with each of the multiple anchors 2. Further, the vehicle interior communication unit 15 may include a circuit for the processor 11 to communicate with other in-vehicle devices via the vehicle interior network. The vehicle interior communication unit 15 may include a PHY chip, a cable connector, and the like conforming to a communication standard of the vehicle interior network.

The position determination device 1 shifts each anchor 2 to the active state in response to the communicative connection with the mobile device 9, and performs distance measurement communication with the mobile device 9. The position determination device 1 acquires data (hereinafter, distance measurement result data) indicating the result of distance measurement communication from each of the multiple anchors 2. The distance measurement result data includes the ID of the mobile device 9 that has performed the distance measurement and data indicating the distance from the anchor 2 to the mobile device 9. A value indicating the distance from the anchor 2 to the mobile device 9 determined by the distance measurement communication may be referred to as a distance measurement value in the present disclosure. When the position determination device 1 is communicatively connected to the multiple mobile devices 9, each anchor 2 performs distance measurement communication with each of the multiple connected mobile devices 9.

The position determination device 1 specifies a distance (hereinafter also referred to as a device distance) from the vehicle Hv to the mobile device 9 based on the distance measurement result data provided from each anchor 2. The position determination device 1 may determine the device distance by combining/integrating distance measurements observed by multiple anchors 2. The device distance may be the minimum value among distance measurements observed by the multiple anchors 2. Further, the position determination device 1 may determine whether the mobile device 9 connected by the short range communication is present inside the vehicle, in a vicinity area, or in other areas based on the distance measurement result data provided from each anchor 2. The vicinity area is an area outside the vehicle that is within a predetermined actuation distance from the vehicle Hv. The actuation distance may be set to 1.0 m, 1.5 m, 2.0 m, or the like. The vicinity area can be understood as an area where the automatic unlocking/locking of the vehicle Hv can be performed. The proximity area may be also referred to as a passive entry area.

The position determination device 1 may determine that the mobile device 9 that is not connected by the short range communication is present in another area. The position determination device 1 provides the position information of the identified mobile device 9 to the body ECU 3.

The position determination device 1 may be attached to the left C-pillar of the vehicle Hv, the instrument panel, the overhead console, the right C-pillar, or under the driver's seat. The C pillar refers to the third pillar from the front among pillars of the vehicle Hv. Of course, the position determination device 1 may be attached.

As described above, the anchor 2 is a device for performing distance measurement communication with the mobile device 9. The anchor 2 can perform the UWB communication. As shown in FIG. 4, the in-vehicle system 10 of the present embodiment includes anchors 2A, 2B, 20, 2D, 2P, and 2Q as anchors 2. The anchor 2A is an anchor 2 placed at a right front corner of the vehicle Hv. The anchor 2A may be placed in the vicinity of the right front wheel, at the right end of a front bumper, at a right side mirror, or the like. The vicinity of a certain member in the description of the mounting position of the anchor 2 may be understood as a range within 0.3 meters from the member. The anchor 2A may be referred to as a right front anchor, a first anchor, or the like.

The anchor 2B is an anchor 2 placed at a left front corner of the vehicle Hv. The anchor 2B may be placed near a left front wheel, at the left end of the front bumper, at a left side mirror, or the like. The anchor 2B may be referred to as a left front anchor or a second anchor. The anchor 2C is an anchor 2 placed at a right rear corner of the vehicle Hv. The anchor 2C may be placed in the vicinity of the right rear wheel, the right end of the rear bumper, or the like. The anchor 2C may be referred to as a right rear anchor or a third anchor. The anchor 2D is an anchor 2 placed at a left rear corner of the vehicle Hv. The anchor 2D may be placed in the vicinity of a left rear wheel, at the left end of a rear bumper, or the like. The anchor 2D may be referred to as a left rear anchor or a fourth anchor.

The anchors 2P and 2Q are anchors 2 placed inside the vehicle. The anchor 2P is placed in front of the anchor 2Q in the vehicle compartment. The anchor 2P may be placed on an instrument panel, the upper end of a windshield, a center console, or the like. The anchor 2P may be also referred to as an interior front anchor or a fifth anchor. The anchor 2Q is an anchor 2 placed behind the anchor 2P in the vehicle. The anchor 2Q may be placed at a rear position, such as a central portion of a rear seat, a ceiling positioned above the rear seat, or a trunk. The anchor 2Q may be also referred to as an interior rear anchor or a sixth anchor.

Since each of the anchors 2A to 2D is attached to the outer surface of the vehicle Hv, the anchors 2A to 2D may be referred to as an exterior device or an exterior anchor. Since each of the anchors 2P to 2Q is attached to the vehicle interior, the anchors 2P to 2Q may be also referred to as an interior device or a vehicle interior anchor.

The configuration and performance of each anchor 2 may be substantially the same. Each anchor 2 includes a vehicle interior communication unit 21 and the UWB module 22, as shown in FIG. 5. The vehicle interior communication unit 21 is a circuit for communicating with the position determination device 1. The vehicle interior communication unit 21 includes a PHY chip or the like according to a communication method (for example, CAN) with the position determination device 1.

The UWB module 22 is a module for performing the UWB communication. The UWB module 22 includes an antenna for UWB communication, a transmission reception circuit, and an UWB controller. The transmission reception circuit is a circuit that executes signal processing related to modulation and demodulation. The UWB controller is a microcomputer. The UWB controller executes a process for distance measurement communication. The process for distance measurement communication includes selecting a communication partner/communication format for each time point according to the distance measurement setting data provided from the position determination device 1. Further, the process for distance measurement communication includes analysis of reception data, output of transmission data, and generation of distance measurement result data. When the UWB controller generates distance measurement result data by performing distance measurement communication with the mobile device 9, the UWB controller transmits (reports) distance measurement result data to the position determination device 1 through the vehicle interior communication unit 21.

The body ECU 3 is an ECU (electronic control unit) that controls body system equipment such as headlights, door lock motors, power window motors, and side mirror motors. The body ECU 3 controls unlocking and locking of the door based on the device position information determined by the position determination device 1. Controlling the unlocking/locking of the door corresponds to controlling the locked state of the vehicle Hv. The body ECU 3 may be understood as an ECU that provides a passive entry function in cooperation with the position determination device 1. The passive entry function is a function of unlocking the vehicle Hv in response to a predetermined user action on the vehicle Hv, such as touching a door handle. The body ECU 3 may be replaced by an integrated ECU, a zone ECU, or a domain ECU. Further, the body ECU 3 and the position determination device 1 may be integrated. The functional arrangement in the in-vehicle system 10 may be changed as appropriate.

In addition to the above, various in-vehicle devices can be directly or indirectly connected to the position determination device 1. For example, the position determination device 1 is connected to a power source ECU, a cellular module, an NFC module, and the like so as to communicate with each other via the vehicle interior network or using a dedicated cable. The power source ECU is an ECU that controls whether the vehicle power is turned on or off. The vehicle power source is a power source that turns on when the vehicle Hv travels. The cellular module is a communication module that performs cellular communication such as 4G and 5G. The NFC module is a communication module for performing near field communication (NFC). The NFC is a communication over a distance of several centimeters to approximately 10 centimeters. In terms of the communicable distance, the NFC and the short range communication of the present disclosure may be understood as different (divergent) communication methods.

### Distance Measurement Communication

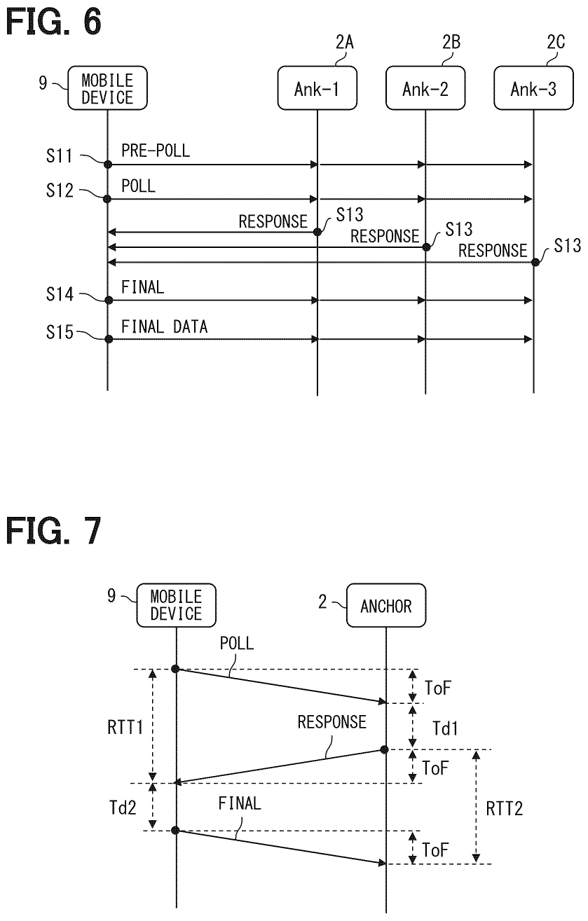

Here, the distance measurement communication performed between one mobile device 9 and the vehicle Hv will be described. The distance measurement communication is communication for measuring the distance based on the propagation time (in other words, flight time) of the radio waves from the anchor 2 to the mobile device 9. The distance measurement communication between the mobile device 9 and the vehicle Hv may be understood as distance measurement communication between the mobile device 9 and the multiple anchors 2. As shown in FIG. 6, the distance measurement communication schematically includes five processes of S11 to S15. In the distance measurement communication, the mobile device 9 operates as an initiator, and each anchor 2 operates as a responder. The “Ank” in the drawings represents an anchor. Although only the anchors 2A to 2C are shown in FIG. 6, the anchors 2D, 2P, and 2Q operate similarly to the anchors 2A to 2C.

The process of S11 (first process) is a process in which the mobile device 9 transmits a pre-poll signal to all the anchors 2. The pre-poll signal is an UWB signal that notifies a communication partner that distance measurement is about to start. The pre-poll signal may be a signal for switching a state of the anchor 2 from a sleep state to an active state.

The pre-poll signal may be broadcast. However, the pre-poll signal may include information specifying the device to be responded to, for example, a vehicle ID. Thereby, it may be possible to prevent the anchor 2 mounted on the vehicle different from the vehicle Hv (that is, the different vehicle) from responding to the pre-poll signal or the like. It is not limited to the pre-poll signal, and any UWB signal transmitted or received may include information specifying the communication partner. The information designating the communication partner may be exchanged by short range communication between the position determination device 1 and the mobile device 9 prior to distance measurement communication. The UWB signal in which the vehicle Hv is set as the communication partner is received by each of the multiple anchors 2 mounted on the vehicle Hv.

The process of S12 is a process in which the mobile device 9 transmits a poll signal to the anchor 2. The pole signal is a signal requesting the anchor 2 to return the response. The transmission of the poll signal may be performed after a predetermined time has elapsed from the transmission of the pre-poll signal. The time difference between the transmission of the pre-poll signal and the transmission of the poll signal may be determined in advance.

The process of S13 is a process in which the anchor 2 transmits a response signal in response to receiving the poll signal. Each of the multiple anchors 2 returns a response signal upon receiving the pole signal. The response signal may be rephrased as an answer signal.

The process of S14 is a process in which the mobile device 9 broadcasts the final signal. The final signal may be a response signal to the response signal. The final signal may be transmitted to all anchors 2 (in other words, the vehicle Hv).

The process of S15 is a process in which the mobile device 9 broadcasts the final data signal. The final data signal may be a signal for notification indicating the end of the current distance measurement communication. The final data signal may include a device measurement result that is distance measurement result distance data generated by the mobile device 9. The device measurement result may be data indicating the distance from the mobile device 9 to each anchor 2.

Further, the final data signal may include information indicating a delay time that is a time from the reception of the response signal to the transmission of the final signal. The reception time of the response signal from each anchor 2 is different. Therefore, the final data signal may include delay time information for each anchor 2.

By performing the distance measurement communication sequence described above, as shown in FIG. 7, the mobile device 9 can acquire the first round trip time (RTT1 in FIG. 7), which is the elapsed time from transmission of the poll signal to reception the response signal. The RTT is an abbreviation for Round Trip Time. The RTT1 is a value obtained by combining a time of flight (ToF) of the radio wave corresponding to the distance from the mobile device 9 to the anchor 2 and an anchor reaction time (Td1). A relationship of RTT1=ToF+Td+ToF is obtained. The anchor reaction time is a delay time from the reception of the poll signal to the transmission of the response signal. The anchor reaction time is a parameter derived from the hardware configuring the anchor 2. The anchor reaction time can be treated as a fixed value. Therefore, by substituting a setting value of the anchor reaction time and an observation value of the RTT1 into the above relational equation, the mobile device 9 can calculate the time of flight (that is, ToF) for one way. The distance from the mobile device 9 to the anchor 2 can be easily calculated from the ToF by using the propagation speed of the radio waves. As described above, the mobile device 9 can generate a device measurement result indicating the distance from the mobile device 9 to each anchor 2 based on the distance measurement communication result.

Further, according to the distance measurement sequence described above, the anchor 2 can acquire the second round trip time (RTT2 in the figure), which is the elapsed time from transmission of the response signal to reception of the final signal. The RTT2 includes a device reaction time (Td2). The device reaction time corresponds to the delay time described above. When the final data signal includes delay time information for each anchor 2, the anchor 2 can specify the device reaction time (Td2) by referring to the final data signal. Therefore, the anchor 2 itself can generate data (hereinafter, anchor measurement result) indicating the distance from the anchor 2 to the mobile device 9 by the distance measurement communication described above. The anchor measurement result corresponds to the distance measurement result described above. The anchor measurement result includes the distance measurement value and information indicating the mobile device 9 on which the measurement was performed. The anchor measurement result may be generated for each anchor 2.

When the final data signal includes the device measurement result, the anchor 2 itself does not need to generate the distance measurement value. When the final data signal includes the device measurement result, the anchor 2 may report the distance value indicated by the final data signal to the position determination device 1.

As another aspect, the process of S14 may be a process in which the mobile device 9 individually transmits the final signal for each anchor 2. In response to receiving the response signal from a certain anchor 2 in S14, the mobile device 9 may unicast the final signal to the transmission source of the response signal. In that case, the device reaction time (Td2) may be regarded as a design value. Therefore, in the configuration in which the mobile device 9 transmits the final signal for each anchor 2, the anchor 2 can generate the distance measurement value by the distance measurement communication described above even when the final data signal does not include delay time information or device measurement results for each anchor 2.

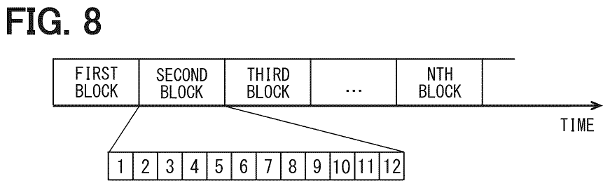

The distance measurement communication between one mobile device 9 and the vehicle Hv is performed by dividing the time into blocks having a predetermined length, as shown in FIG. 8. The block includes multiple rounds. The round is shown in FIG. 8 when one block includes twelve rounds. The round is obtained by dividing the blocks by a predetermined number. The number of rounds provided in a block may be variable.

The distance measurement communication between the mobile device 9 and the vehicle Hv is performed within one round. That is, the communication sequence shown in FIG. 6 is executed within one round. One mobile device 9 and the vehicle Hv perform distance measurement communication only once per block.

The number of rounds in which the mobile device 9 performs distance measurement communication may differ for each block. For example, in the first block, distance measurement communication may be performed in the fifth round, while in the second block, distance measurement communication may be performed in the eleventh round. The number of the round in which the mobile device 9 performs the distance measurement communication is determined by a hopping key and an interval agreed in advance between the mobile device 9 and the position determination device 1 as the distance measurement setting.

The mobile device 9 and the position determination device 1 exchange distance measurement setting data in response to the communication connection by short range communication. The distance measurement setting data is a data set including parameters (hereinafter also referred to as distance measurement parameters) for distance measurement communication. The distance measurement setting data may be understood as a parameter set that defines the execution rule of the repetitive distance measurement communication. The position determination device 1 may transmit a desirable distance measurement setting to the mobile device 9 via short range communication, and the mobile device 9 may accept or modify the proposal of the position determination device 1.

The distance measurement setting data may include interval, round number, hopping key, number of anchors, and communication format information. The interval is a parameter that defines the length of the block. The value of the interval (in other words, block size) included in the distance measurement setting may be expressed in the time dimension such as 100 milliseconds or the like. The interval may be expressed by the number of rounds. The interval may be selected from multiple candidates (options) prepared in advance, such as 8, 12, 16, 20, and 24 rounds. The number of rounds including the interval may be set to a multiple of four. Since the mobile device 9 and the vehicle Hv are configured to perform distance measurement communication once in a block, the length of the block can be an average interval of distance measurement communication. The interval may be understood as a parameter that defines the average value (in other words, expected value) of the interval of distance measurement communication. The interval setting value may be different for each mobile device 9. The setting value of the number of rounds included in the distance measurement setting data defines the number of rounds that one block has. The distance measurement setting data may include either the interval setting value or the number of rounds. Data indicating the interval setting value corresponds to interval information.

The hopping key is a parameter for determining a round number (hereinafter, used round number) for distance measurement communication in the block. The hopping key may be understood as a parameter for changing the used round number for each block. The setting value of the hopping key may be randomly determined within a selectable range. The value of the hopping key may be fixed for each mobile device 9. Each UWB module can identify the use round number for each block when the hopping key and the number of rounds are fixed. The use round number may be determined by inputting the hopping key and the number of rounds to a predetermined function or program. The function/program for determining the use round number may be configured so that the use round number for each block is pseudo-random. The function/program for determining the use round number based on the hopping key may be common to multiple UWB modules. Data indicating the setting value of the hopping key corresponds to hopping information.

The number of anchors is a parameter indicating the number of anchors 2 included in the vehicle Hv. Since the distance measurement setting data includes the number of anchors, the mobile device 9 can recognize the number of communication partners. In the present technical field, the anchor 2 may be simply referred to as an antenna. The number of anchors may be also referred to as the antenna number.

The communication format information is a code indicating which communication format to use among the multiple communication formats defined in the UWB standard. The communication format information may be a code specifying the order in which the data is arranged, the length of the preamble, or the like. Further, the communication format information may be information specifying the channel (bandwidth) to be used, the modulation method, the pulse width, and the like. The communication format may be rephrased as a communication method, a communication protocol, a mode, or the like.

In addition, the distance measurement setting data may include a setting value of a length (hereinafter, round length) of one round. The round length may be changeable in three stages: standard, short, and long. The round length may be adjusted to be longer as the number of anchors increases.

### Communication Connection to Distance Measurement Communication

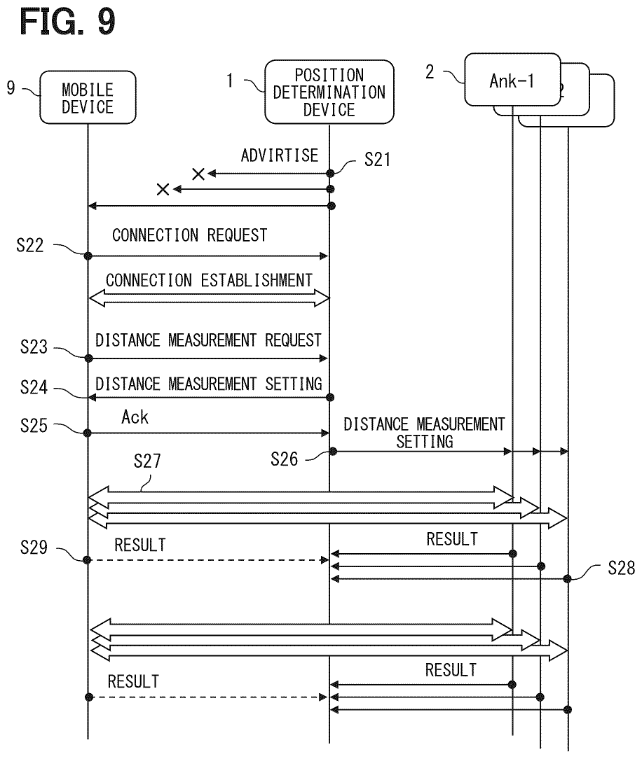

FIG. 9 is a sequence diagram showing an operation of the entire system from the communication connection to the start of distance measurement communication. It is assumed that the mobile device 9 shown in FIG. 9 is sufficiently away from the vehicle Hv at the time of starting the sequence shown in FIG. 9, and the position determination device 1 is not connected in communication. The position determination device 1 may be waiting at the time of starting the sequence shown in FIG. 9. The state of waiting refers to a state where the mobile device 9 is not communicatively connected to any mobile device 9.

At the time of starting the sequence shown in FIG. 9, the position determination device 1 may have already been communicatively connected to the different mobile device 9. The position determination device 1 may periodically execute an advertisement signal to detect the approach of another mobile device 9 even when the communication connection has been completed with one mobile device 9.

In the standby state, the position determination device 1 periodically transmits an advertisement signal (S21). When the mobile device 9 enters the short range communication area of the position determination device 1 as the user moves, the mobile device 9 can receive the advertisement signal. The mobile device 9 transmits a connection request signal in response to receiving an advertisement signal from the position determination device 1 (S22), and establishes a connection with the position determination device 1.

Thereafter, the mobile device 9 transmits a distance measurement setting request signal to the position determination device 1 via short range communication (S23). The distance measurement setting request signal is a short range communication signal requesting transmission of distance measurement setting data. Upon receiving the distance measurement setting request signal from the mobile device 9, the position determination device 1 returns the distance measurement setting data to the mobile device 9 (S24). S23 may be any element and may be omitted. The position determination device 1 may transmit distance measurement setting data in response to communicative connection with the mobile device 9.

Upon receiving the distance measurement setting data from the position determination device 1, the mobile device 9 returns a positive response (so-called Ack) (S25). Upon receiving the Ack from the mobile device 9, the position determination device 1 notifies all anchors 2 of the distance measurement setting data and information of the mobile device 9 that becomes the communication partner (S26).

The return of the Ack to the reception of the distance measurement setting data is an optional element and may be omitted. In that case, the position determination device 1 may generate distance measurement setting data at any timing after the communication connection with the mobile device 9, and transmit the information of the mobile device 9 and the distance measurement setting data to all the anchors 2. Before S26, there may be a process of returning the state of the anchor 2 from the sleep state to the active state.

In the present embodiment, the position determination device 1 determines the values of various distance measurement parameters. However, it is not limited to this. The mobile device 9 may determine some or all of the distance measurement parameters. The process of S24 may be a process in which the mobile device 9 transmits the distance measurement setting data to the position determination device 1, in other words, a process in which the mobile device 9 proposes the distance measurement setting to the position determination device 1.

When the exchange of the distance measurement setting or the agreement of the distance measurement setting is completed, the repetitive distance measurement communication starts. That is, the mobile device 9 and each anchor 2 transmit and receive the UWB signal for distance measurement (S27). The UWB signal for distance measurement includes the above-described pre-poll signal, poll signal, response signal, final signal, final data signal, and the like.

Each anchor 2 transmits the anchor measurement result determined as the result of the distance measurement communication to the position determination device 1 each time one distance measurement communication is completed (S28). The mobile device 9 may also transmit data indicating the distance (that is, distance measurement result) to each anchor 2 to the position determination device 1 via the short range communication (S29). S29 may be an optional element and may be omitted.

In S28 or S29 and subsequent processes, S27 to S28 (or S27 to S29) are repeated until the predetermined end condition is satisfied. When the end condition is satisfied, the distance measurement communication between the mobile device 9 and the vehicle Hv ends. The end condition may be a disconnection of the communication connection between the position determination device 1 and the mobile device 9. The position determination device 1 can disconnect communication with the mobile device 9 when no signal from the mobile device 9 continues for a predetermined time (for example, Super Vision Time). Further, when the end request signal (TERMINATE_IND) is received from the mobile device 9 via short range communication, the position determination device 1 may determine that the end condition is satisfied. The mobile device 9 may be capable of transmitting an end request signal in response to a user operation or a low battery charge.

### Collision of Distance Measurement Timing

When there are multiple mobile devices 9 around the vehicle Hv, the position determination device 1 connects to each of the multiple mobile devices 9 via short range communication. Further, when the position determination device 1 is connected to multiple mobile devices 9 by short range communication, the position determination device 1 exchanges distance measurement setting data with each of the multiple mobile devices 9. Then, the position determination device 1 causes each anchor 2 to perform distance measurement communication with the multiple mobile devices 9 in parallel.

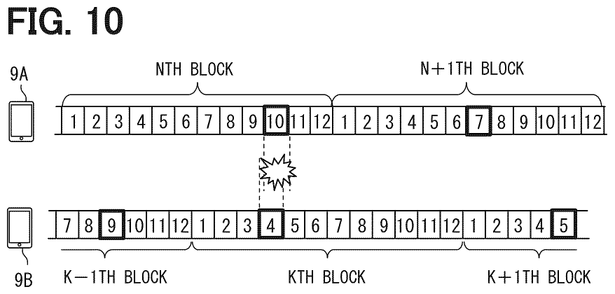

As described above, the distance measurement communication between one mobile device 9 and the vehicle Hv is intermittently (repeatedly) performed. When the vehicle Hv performs distance measurement communication with multiple mobile devices 9, the distance measurement timings of the two mobile devices 9 may accidentally overlap (in other words, collide) as shown in FIG. 10. The distance measurement timing is a timing for performing the distance measurement communication.

FIG. 10 shows a case where the distance measurement timing of the mobile device 9a in the N-th block and the distance measurement timing of the mobile device 9b in the K-th block overlap. Specifically, it shows a case where distance measurement communication between the mobile device 9a and the vehicle Hv is scheduled for the tenth round of the N-th block and also distance measurement communication between the mobile device 9b and the vehicle Hv is scheduled for the fourth round of the K-th block. The round surrounded by the thick frame is the round in which distance measurement communication is scheduled. Since the timing of the communication connection differs for each mobile device 9, the round number and block number corresponding to the same time may differ for each mobile device 9. The “N” and the “K” in the present description may be arbitrary numbers.

Basically, the UWB module 22 cannot communicate with the two mobile devices 9 completely simultaneously. Therefore, when the distance measurement timings in a certain block overlap, the distance measurement communication with either mobile device 9 becomes impossible (failed) in at least the block.

Here, it is assumed that the distance measurement timings of the mobile devices 9a and 9b collide in a situation where the mobile device 9a is very close to the vehicle Hv and the mobile device 9b is relatively far from the vehicle Hv. Since the mobile device 9a is close to the vehicle Hv, the user (that is, the first user) of the mobile device 9a is more likely to use the vehicle Hv than the user of the mobile device 9b.

In the above case, when the distance measurement communication with the mobile device 9b is prioritized and the distance measurement communication of the mobile device 9a becomes impossible, the distance measurement communication between the mobile device 9a and the vehicle Hv is postponed until a predetermined round (for example, the seventh round) of the N+1 block. As a result, the detection by the position determination device 1 of the approach of the first user to the vehicle Hv is delayed, and the convenience of the first user may be impaired.

### Measurement Against Collision of Distance Measurement Timing

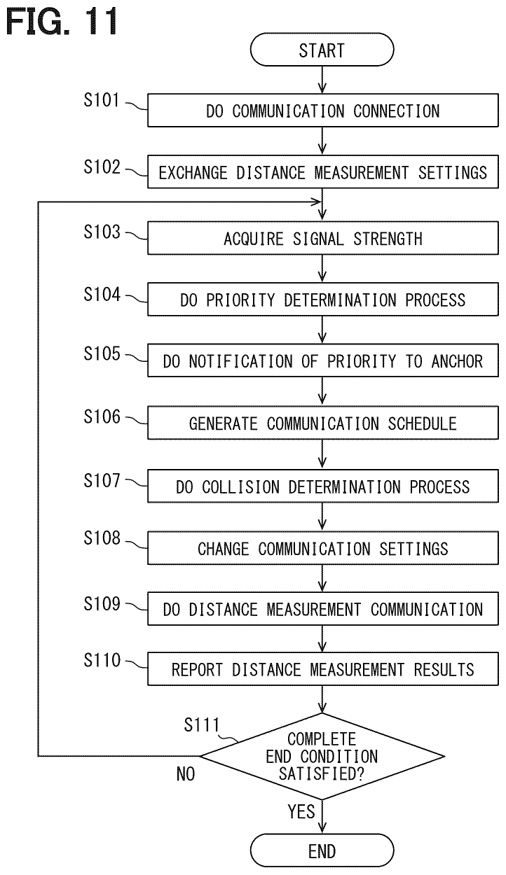

FIG. 11 is a flowchart for illustrating an operation flow of the entire system that incorporates the countermeasures against the collision of the distance measurement timing described above, and includes processes S101 to S111. The process of S101 is a process in which the position determination device 1 communicates with the mobile device 9 existing within the short range communication area of the position determination device 1. The process of S101 may be executed based on the reception of the connection request signal from the unconnected mobile device 9. When the position determination device 1 is set to act as the central, the process of S101 may be executed based on reception of the advertisement signal from the unconnected mobile device 9. The process of S101 may include a process of determining whether to receive the connection request signal or the advertisement signal from the unconnected mobile device 9. S101 may also be executed at a predetermined cycle when S102 and subsequent processes are being executed. The position determination device 1 as the execution subject of the following processes may be referred to as a processor 11.

The process of S102 is a process in which the position determination device 1 exchanges distance measurement setting data with the newly connected mobile device 9 in S101. S102 may be executed in response to the execution of S101. In this S102, the distance measurement parameters such as the interval, the number of rounds, the hopping key, and the like are determined. The process of S102 includes notifying all the anchors 2 of the distance measurement setting agreed with the mobile device 9.

The process of S103 is a process in which the position determination device 1 acquires the reception strength of the short range communication signal transmitted from the connection device. The connection device is a mobile device 9 that has been communicatively connected by the position determination device 1 via short range communication. When there are multiple connection devices, the position determination device 1 acquires the reception strength for each of the multiple connection devices. The signal used to measure the reception strength may be any signal, such as a signal for maintaining connection. In the communication connection state by the short range communication, the position determination device 1 and the mobile device 9 exchange data packets (for example, Empty Packet) at a predetermined connection interval in order to maintain the connection.

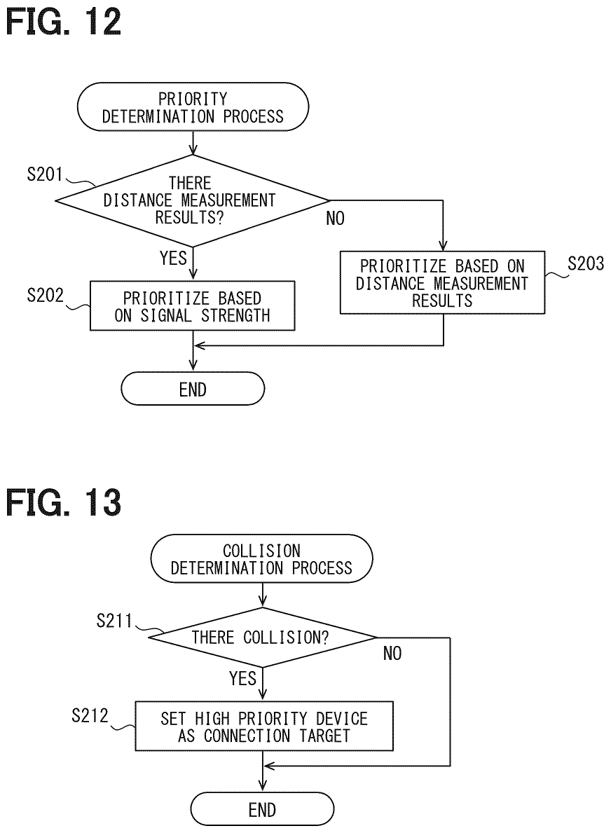

The process of S104 is a process in which the position determination device 1 executes the priority determination process. The priority determination process is a process of determining the priority for performing distance measurement communication to the connection device. As shown in FIG. 12, the priority determination process includes processes S201 to S203. The process of S201 is a process of determining whether there is the distance measurement result for each connection device. When the distance measurement result has been obtained for any connection device (YES in S201), the priority is set in order of the shortest distance from the vehicle Hv. The position determination device 1 sets the priority of the connection device whose distance is short from the vehicle Hv to the highest priority. The proximity to the vehicle Hv may be evaluated based on the magnitude of the measured device distance.

When the distance measurement result has not been obtained for any of the connection devices (NO in S201), the priority is set in descending order of the reception strength of the short range communication signal. That is, the connection device with the relatively high reception strength is set to have a higher priority than the connection device with the relatively low reception strength.

When there is only one connection device, the priority of the connection device may be set to first. Further, among the mobile devices 9 registered in the position determination device 1, the priority of the mobile device 9 that is not communicatively connected to the position determination device 1 may be set to a lower priority than the connection device, such as the lowest priority. Since the position determination device 1 does not perform distance measurement communication with the mobile device 9 that is not communicatively connected, the position determination device 1 may not set the priority of the mobile device 9 that is not connected.

Further, when the connection device for which distance measurement communication has been performed and the connection device for which distance measurement communication has not been performed are present, the position determination device 1 may set the priority of the connection device for which distance measurement communication has been performed to be higher than that of the connection device for which distance measurement communication has not been performed. When there are multiple connection devices that have already performed distance measurement communication, the position determination device 1 may set a higher priority for the connection device with the shorter distance from the vehicle Hv than for the connection device with the farther distance from the vehicle Hv. When there are multiple connection devices that have not performed distance measurement communication, the position determination device 1 may set a higher priority for the connection device with the large reception strength than for the connection device with the small reception strength.

By the way, there may be cases where the user enables the short range communication function of the mobile device 9 after approaching the vicinity of the vehicle Hv. In such a case, although the distance measurement result has not been acquired, the reception strength is high. Assuming the case described above, the priority of the connection device for which distance measurement communication has not been performed and whose reception strength is equal to or higher than a predetermined value may be set to an exceptionally high value. The position determination device 1 may set the priority of the connection device whose distance measurement communication has not been performed and whose reception strength is equal to or higher than a predetermined value to first. According to this configuration, it is possible to perform the first distance measurement communication with the mobile device 9 that may be near the vehicle Hv at an early stage. The priority determination process may also be executed periodically.

When the prioritization for each connection device is completed, the position determination device 1 notifies all anchors 2 of the priority determined in S104 for each connection device as a process of S105. Thereby, each anchor 2 can determine the mobile device 9 that should preferentially communicate when the distance measurement timings overlap.

The process of S106 is a process in which the anchor 2 generates a communication schedule based on, for each connection device, the communication settings of which notification is provided from the position determination device 1. Generating the communication schedule includes determining a communication partner for each time point. Generating the communication schedule may include determining the channel number to be used, the communication format, and the like for each time point within a predetermined time point. The process of S106 may be a process of identifying the next distance measurement timing for each connection device. S106 may also be executed periodically.

The process of S107 is a process in which each anchor 2 executes the collision determination process. The collision determination process may include processes S211 and S212 as shown in FIG. 13. The processes of S211 to S212 may be executed by each of the multiple anchors 2. The process of S211 is a process of determining whether a collision of distance measurement timings occurs within the immediate neighborhood predetermined time based on the communication settings for each connection device. In S211, the anchor 2 verifies whether communication with the multiple connection devices is scheduled at the same time based on the communication schedule generated in S106. In other words, in S211, the anchor 2 determines whether the measurement timings of the multiple connection devices overlap. When there is only one connection device, each anchor 2 may determine that there is no collision of distance measurement timings.

When determining that there is the overlap (collision) in the distance measurement timing (YES in S211), the anchor 2 sets the communication partner at the collision timing to the high priority device in S212, and ends this flow. The collision timing means a time/period when overlapping measurement timings occur. The process of S212 corresponds to a process in which the anchor 2 adjusts the communication schedule. Here, the high priority device is a connection device having a relatively high priority among two connection devices whose distance measurement timings overlap. On the other hand, in the present disclosure, among the two connection devices whose distance measurement timings overlap, the connection device having the relatively low priority is also referred to as a low priority device. The connection devices whose distance measurement timings overlap may be also referred to a connection device in a state where the measurement timings overlap.

On the other hand, when the anchor 2 determines that there is no collision of the distance measurement timing (NO in S211), the anchor 2 may switch the communication setting according to the schedule generated in S106. Therefore, the collision determination process ends without any special processing. The processes of S211 to S212 may be incorporated in S106.

Each anchor 2 changes the communication setting as a process of S108 as needed based on the communication schedule determined in the above process. The process of S108 is a process of switching the communication setting such as the use channel or the communication format to a setting according to the communication partner. The process of S108 may be executed periodically at intervals shorter than the round. Alternatively, the process of S108 may be executed before a predetermined time at which the next distance measurement communication is scheduled.

The process of S109 is a process in which each anchor 2 and the mobile device 9 perform distance measurement communication. The process of S110 is a process in which each anchor 2 reports the distance measurement result (that is, anchor measurement result) to the position determination device 1. The series of processes in S108 to S110 may be executed in parallel with other processes as needed.

The process of S111 is a process in which the position determination device 1 determines whether the complete end condition is satisfied. The complete end condition may be that none of the connection devices are left. Further, the position determination device 1 may determine that the complete end condition is satisfied when a certain time (for example, five minutes) has elapsed since the vehicle Hv was locked.

When the position determination device 1 determines that the complete end condition is satisfied (YES in S111), a predetermined close process is executed, and the in-vehicle system 10 shifts to the standby state. The close process may include outputting a predetermined control signal to each anchor 2 and transitioning to the sleep state. Further, the close process may include storing, in the storage 13, information of the mobile device 9 connected to the end and information of the mobile device 9 detected to have entered the vehicle. The standby state of the in-vehicle system 10 may be a state where each anchor 2 is in the sleep state and the position determination device 1 is waiting for connection with the mobile device 9. The sleep state of the anchor 2 may be a state where the UWB module 22 is sleeping.

### Operation and Effects

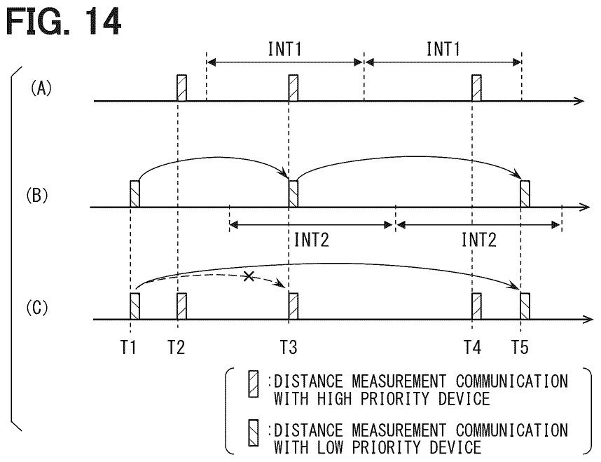

FIG. 14 is a time chart showing the operation of the anchor when the measurement timings with the multiple mobile devices 9 overlap. A part (A) of FIG. 14 shows a communication schedule with a high priority device. A part (B) shows a communication schedule with a low priority device. A part (C) shows a communication schedule with all connection devices for the anchor 2. The part (C) corresponds to a diagram obtained by integrating parts (A) and (B). A time T3 is a timing when the distance measurement timings with the multiple mobile devices 9 overlap. In FIG. 14, “INT1” indicates the design value of the interval with the high priority device, and “INT2” indicates the design value of the interval with the low priority device.

In the in-vehicle system 10 described above, when the distance measurement timings with the multiple mobile devices 9 overlap, the anchor 2 executes the distance measurement communication of the high priority device as scheduled as shown in FIG. 14, and postpones the distance measurement communication with the low priority device until the next distance measurement timing determined by the interval setting value. The next distance measurement timing for the low priority device is T5 shown in FIG. 14.

According to this configuration, when the distance measurement timings with the multiple mobile devices 9 overlap, it is possible to reduce the possibility of postponing the distance measurement communication with the device that is likely to be present near the vehicle Hv in the next time. As a result, it is possible to reduce the possibility that the timing at which the position determination device 1 detects that the user is approaching the vehicle Hv is delayed. In addition, it may be possible to reduce the system response delay to the user approach to the vehicle Hv.

### Modification

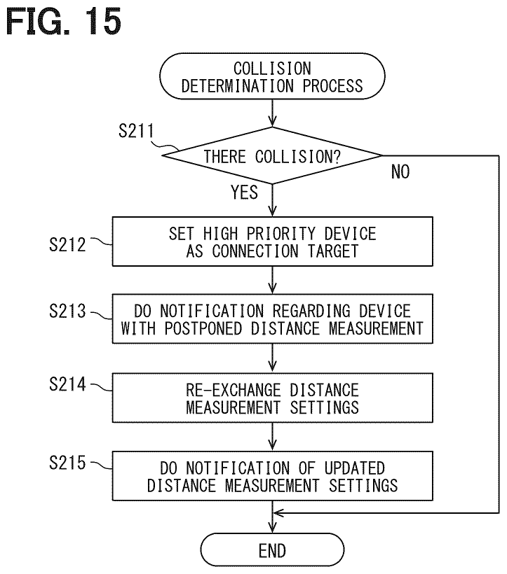

The position determination device 1 may change the distance measurement setting of the low priority device when a collision of the distance measurement timing occurs. Specifically, as shown in FIG. 15, when the communication partner at the collision timing is set to the high priority device in S212, the anchor 2 may transmit, to the position determination device 1, information of the mobile device 9 (that is, the low priority device) for which the distance measurement communication has been postponed in S213. In S214, the position determination device 1 may exchange distance measurement setting data by short range communication with the low priority device, and may increase the interval. When the current interval value of the low priority device is 100 milliseconds, the new interval value may be set to 125 milliseconds or 150 milliseconds. The extension amount of the interval may be four rounds or eight rounds.

When the change of the distance measurement setting with the low priority device is completed, the position determination device 1 transmits the updated distance measurement setting to each anchor 2 in S215. Thereby, it may be possible to reduce the possibility of a re-collision of the distance measurement timing between the low priority device and the high priority device. Note that increasing the interval value corresponds to increasing the size of the block.

In the above, the priority of each mobile device 9 is dynamically determined based on the reception strength of the short range communication signal and the distance information (that is, distance measurement value) obtained as a result of the distance measurement communication. However, the position determination device 1 does not necessarily need to use the distance measurement value. Even after starting the distance measurement communication, the position determination device 1 may determine the priority based on the reception strength of the short range communication signal. Further, in another aspect, the position determination device 1 may determine the priority using the distance measurement value without using the reception strength of the short range communication signal. The position determination device 1 may set the priority of the mobile device 9 for which distance measurement communication has been performed to be higher than the priority of the mobile device 9 for which distance measurement communication has not been performed. Alternatively, conversely, the position determination device 1 may set the priority of the mobile device 9 that has not performed the distance measurement communication to be higher than the priority of the mobile device 9 that has performed the distance measurement communication.

Data indicating the priority of each mobile device 9 may be registered in advance in the storage 13 of the position determination device 1. The priority of the mobile device 9 (hereinafter referred to as the owner device) owned by the owner may be set to the highest priority. Further, the priority order of a guest device that is the mobile device 9 other than the owner may be the order in which the device information is registered in the position determination device 1, in other words, the order in which it is paired. The guest device may also be referred to as a family device or a friend device.

Hereinafter, the priority registered in the storage 13 will be referred to as a registered priority. The registered priority may be changed according to the frequency of use of the vehicle Hv for each user. The more frequently the user uses the vehicle Hv, the higher the registered priority of the mobile device 9 of the user may be set.

Further, the registered priority for each mobile device 9 may be changed according to the elapsed time since the user of each mobile device 9 last used the vehicle Hv. The newer the last use date and time, the higher the priority is set. Specifically, the registered priority of the mobile device 9 with the latest last use date and time may be set to be higher than that of the other mobile devices 9. The date and time when the vehicle Hv is used for each mobile device 9 may be the date and time when the mobile device 9 entered the vehicle, or the date and time when the vehicle Hv was used for unlocking, and the like.

The registered priority may be updated at predetermined intervals, such as daily or weekly. The priority of the owner device may be fixed to first. Further, the position determination device 1 may update the priority of all mobile devices 9 based on the use frequency, last use date and time, and the like without distinguishing between the owner device and the guest device.

The position determination device 1 may perform priority control when the distance measurement timing conflicts based on the registered priority as described above without real-time prioritization using the reception strength and/or distance measurement results.

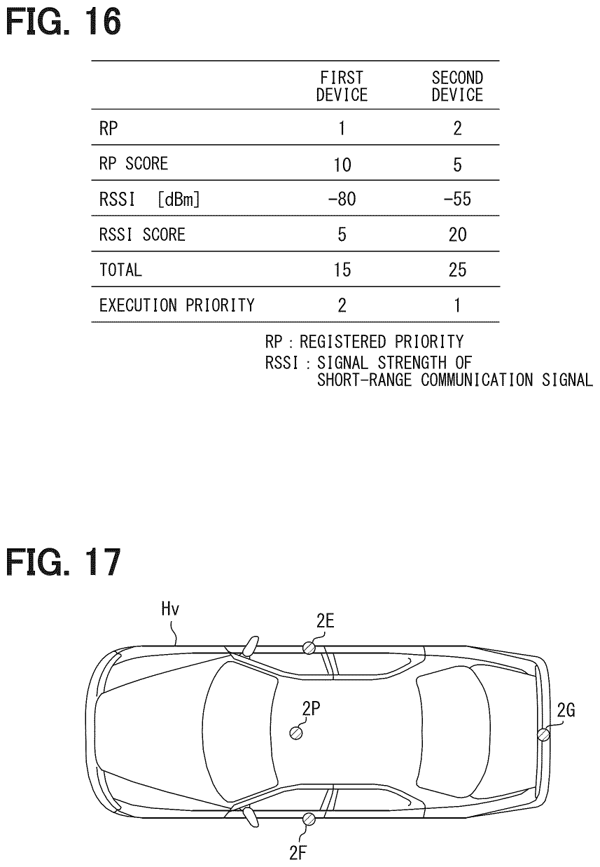

Furthermore, the position determination device 1 may dynamically determine the priority based on both the registered priority and the reception strength in short range communication. As shown in FIG. 16, the position determination device 1 calculates the sum of a score according to the registered priority and a score according to the reception strength (that is, RSSI: Received Signal Strength Indicator/Indication) of the short range communication signal from the mobile device 9 for each mobile device 9. Then, the position determination device 1 may determine the final priority (hereinafter, effective priority) in descending order of the total value. A function, rule, or program that converts the registered priority and reception strength into scores may be appropriately designed. The score according to the registered priority may be understood as a basis point. The score according to the registered priority may be understood as a point component that roughly indicates the device distance. The RP score in FIG. 16 means a score according to the registered priority, and the RSSI score means a score based on the RSSI. According to this configuration, it is possible to apply the priority according to both the user attribute behind the registered priority, the use frequency, the last use date and time, and the current device distance.

Similarly, the position determination device 1 may comprehensively determine the priority based on both the registered priority and the measured device distance. Furthermore, the position determination device 1 may comprehensively determine the priority based on the registered priority, the reception strength, and the distance measurement result. The position determination device 1 calculates a score according to the registered priority, a score according to the reception strength, and a score according to the distance measurement result for each mobile device 9. Then, for each mobile device 9, the sum of scores may be calculated, and the effective priority may be determined in order of increasing the sum. A function that converts the device distance into a score may be appropriately designed.

In the above, the aspect that each anchor 2 determines whether there is the collision of the distance measurement timing has been described. However, the position determination device 1 may determine whether there is the collision of the distance measurement timing. The position determination device 1 may calculate the next distance measurement timing for each connection device based on the distance measurement setting for each connection device, and determine whether there is a collision of distance measurement timings. When the position determination device 1 detects a collision at the distance measurement timing, it may notify each anchor 2 of the connection device to be communicated at the collision timing based on the priority order for each connection device. Each anchor 2 may apply a setting for communicating with the connection device notified (instructed) from the position determination device 1 at the collision timing. Further, in a configuration in which the position determination device 1 determines whether there is the collision of the distance measurement timings itself, the process of changing the distance measurement setting with the low priority device (S214) may be executed without notification from the anchor 2.

Further, the position determination device 1 may change the execution interval (that is, interval) of the distance measurement communication according to whether the vehicle Hv is traveling. When the vehicle Hv is traveling, the position determination device 1 or the mobile device 9 may set the interval longer than when the vehicle Hv is stopped. The interval during traveling may be set to twice, three times, four times, or ten times the interval during stopping. The position determination device 1 or the mobile device 9 may not perform distance measurement communication when the vehicle Hv is traveling. The mobile device 9 may mainly execute the above control. The mobile device 9 may determine whether the vehicle Hv is moving based on the output of an acceleration sensor built into the device or the movement speed of position information based on the GNSS.

In the above, the case where the distance measurement timings of the two mobile devices 9 collide has been described. However, three or more mobile devices 9 may overlap. At the collision timing involving three or more mobile devices 9, the position determination device 1 may perform distance measurement communication with the mobile device 9 having the highest priority among the multiple mobile devices 9 having the overlapping distance measurement timings, and postpone distance measurement communication with the other mobile devices 9 to the next time. When the distance measurement timings of the three or more mobile devices 9 overlap, the highest priority device among the three mobile devices 9 corresponds to the high priority device, and the remaining device corresponds to the low priority device. The expression of multiple mobile devices with overlapping distance measurement timings may be understood as two or more mobile devices with overlapping distance measurement timings.

### UWB Communication

In the UWB communication, multiple channels can be used as defined in IEEE 802.15.4z. The IEEE (registered trademark) is an abbreviation for Institute of Electrical and Electronics Engineers. The anchor 2 and the mobile device 9 may be configured to communicate using a third channel, a fifth channel, a ninth channel, or another channel of UWB communication. The anchor 2 and the mobile device 9 may be configured to selectively communicate using multiple channels. The third channel is a channel having a center frequency of 4492 MHZ, and the fifth channel is a channel having a center frequency of 6489.6 MHz. The ninth channel is a channel having a center frequency of 7987.2 MHz. Each channel corresponds to a frequency band of ±250 MHz from the center frequency. In the UWB communication, 3.1 GHz to 4.8 GHZ, 6.0 GHz to 10.6 GHZ, and the like may be used. The modulation method of the UWB communication may be an on-off keying (OKK) method, a pulse position modulation (PPM) method, a pulse width modulation (PWM), or the like. The on-off keying method is a method for expressing information (for example, 0 and 1) based on the presence or absence of an impulse signal. The pulse position modulation method is a method of modulating at a pulse generation position. The pulse-width modulation method is a method of expressing information by combining pulses. The UWB communication between the anchor 2 and the mobile device 9 may be performed by the OOK method. The data transmission by the UWB communication is implemented using multiple impulse signals. Since the UWB signal includes multiple impulses, it may be rephrased as a pulse sequence signal.

The mounting position of the anchor 2 is not limited to the placement pattern shown in FIG. 3. For example, the in-vehicle system 10 may include anchors 2E, 2F, 2G, and 2P as shown in FIG. 17. The anchor 2E is an anchor 2 built into an outer door handle for a right front seat. The anchor 2E may be placed on the right B-pillar, the right side mirror, the right side sill, or the right edge of the roof. The anchor 2E may be rephrased as a right anchor. The anchor 2F is an anchor 2 built into an outer door handle for a left front seat. The anchor 2F may be placed on the left B-pillar, the left side mirror, the left side sill, or the left edge of the roof. The anchor 2F may be rephrased as a left anchor. The anchor 2G is an anchor 2 placed at a central portion of the rear bumper, a trunk door handle, or an upper or lower end of the rear window. The anchor 2G may be referred to as a rear anchor. As described above, the anchor 2P is an anchor 2 placed inside the vehicle. Even in a configuration including the anchors 2E to 2G, the in-vehicle system 10 may include the anchor 2Q in addition to the anchor 2P. Further, the in-vehicle system 10 may include a front anchor placed at the center of the front end of the vehicle Hv.

The UWB-IR is a first wireless protocol, and Bluetooth LE is a second wireless protocol. The communication method (in other words, first wireless protocol) between the anchor 2 and the mobile device 9 is not limited to UWB-IR, and may be Bluetooth LE, Bluetooth Classic, Wi-Fi, EnOcean (registered trademark), Zigbee (registered trademark), or the like. Similarly, the communication method (that is, the second wireless protocol) between the position determination device 1 and the mobile device 9 may be Wi-Fi or the like. Descriptions of wireless protocols, communication standards, and communication methods in the present disclosure may be mutually replaced.

### First Note

The present disclosure also includes the following technical ideas. Further, the scope of the present disclosure also includes a distance measurement method, a control device, and a program corresponding to the following technical ideas.

### First Technical Idea

A distance communication system includes: a communication unit configured to perform distance measurement communication with multiple mobile devices using a predetermined wireless protocol; and a control device including a storage that stores information of the multiple mobile devices that are a position determination target. The control unit is configured to prioritize the multiple mobile devices, and notify the communication unit of a priority of each mobile device. The communication unit or the control device is configured to identify a distance measurement timing that is an execution timing of the distance measurement communication for each mobile device, and determine whether a collision timing is present at which the distance measurement timing of the multiple mobile devices overlaps. The communication unit is configured to perform the distance measurement communication with a high priority device. The high priority device is a mobile device having a higher priority than a priority of a different mobile device among the two mobile devices in a state where the distance measurement timing overlaps at the collision timing.

### Second Technical Idea

In the distance measurement system according to the first technical idea, the communication unit is configured to repeat the distance measurement communication with each of the multiple mobile devices according to a distance measurement interval set for each of the multiple mobile devices, apply a setting for performing the distance measurement communication with the high priority device at the collision timing, and postpone the distance measurement communication with a low priority device that is a mobile device having a lower priority than a different mobile device among the two mobile devices in the state where the distance measurement timing overlaps to a next time determined by the distance measurement interval.

### Third Technical Idea

In the distance measurement system according to first technical idea or second technical idea, the communication unit is configured to repeat the distance measurement communication with each of the multiple mobile devices according to a distance measurement interval set for each of the multiple mobile devices, determine whether the collision timing is present, and when determining that the collision timing is present, notify the control device of information of a low priority device that is a mobile device having a lower priority than a priority of a different mobile device among the multiple mobile devices in the state where the distance measurement timing overlaps. The control device is configured to communicate with the low priority device for changing the distance measurement interval with the low priority device.

### Fourth Technical Idea

In the distance measurement system according to the first technical idea, the storage stores data indicating the priority for each mobile device.

### Fifth Technical Idea

In the distance measurement system according to any one of the first to third technical ideas, the control device is configured to determine the priority of each mobile device based on a result of the distance measurement communication.

### Sixth Technical Idea

In the distance measurement system according to any one of the first to third technical ideas, the communication unit is a first communication unit, and the different measurement system further includes a second communication unit configured to wirelessly communicate with the multiple mobile devices by using a wireless protocol different from the wireless protocol supported by the communication unit, the control unit is configured to acquire data indicating a reception strength of a signal transmitted by the mobile device from the second communication unit and determine the priority for each mobile device based on the reception strength for each mobile device.

### Seventh Technical Idea

In the distance measurement system according to any one of the first to sixth technical ideas, the control unit is configured to set a priority of a mobile device that has not performed the distance measurement communication among the multiple mobile devices to be lower than a priority of a mobile device that has performed the distance measurement communication.

### Eighth Technical Idea

In the distance measurement system according to any one of the first to seventh technical ideas, the communication unit or the control device is configured to determine whether the distance measurement timing overlaps based on setting data for the distance measurement communication with the multiple mobile devices.

### Ninth Technical Idea

In the distance measurement system according to the eighth technical idea,

the setting data includes interval information for defining a distance measurement interval and hopping information for determining an execution timing of the distance measurement communication within a period corresponding to the distance measurement interval.

### Tenth Technical Idea

In the distance measurement system according to any one of the first to ninth technical ideas, the communication unit is configured to perform the distance measurement communication using ultra wide band communication.

### Eleventh Technical Idea

In the distance measurement system according to the sixth technical idea, a first wireless protocol that is the wireless protocol supported by the first communication unit is ultra wide band communication, and a second wireless protocol that is the wireless protocol supported by the second communication unit is Bluetooth (registered trademark) Low Energy.

### Twelfth Technical Idea

In the distance measurement system according to any one of the first to eleventh technical ideas, the communication unit is a first communication unit, and the distance measurement system further includes a second communication unit configured to wirelessly communicate with the multiple mobile devices by using a wireless protocol different from the wireless protocol supported by the communication unit. The control device is configured to acquire data indicating a reception strength of a signal transmitted by the mobile device from the second communication unit. After the second communication unit communicatively connects to the mobile device, the priority of the mobile device that has performed the distance measurement communication at least once is set to be higher than the priority of the mobile device that has not yet performed the distance measurement communication at least once.

### Thirteenth Technical Idea

In the distance measurement system according to any one of the first to twelfth technical ideas, the communication unit is a first communication unit, and the distance measurement system further includes a second communication unit configured to wirelessly communicate with the multiple mobile devices by using a wireless protocol different from the wireless protocol supported by the communication unit. The control device is configured to acquire data indicating a reception strength of a signal transmitted by the mobile device from the second communication unit. When the reception intensity of a signal from the mobile device that has not yet performed the distance measurement communication once after the second communication unit communicatively connects to the mobile device is equal to or higher than a predetermined value, the control device sets the priority of the mobile device to the highest.

### Fourteenth Technical Idea

A control device includes a storage that stores information of multiple mobile devices that are a position determination target, and is configured to: prioritize the multiple mobile devices; notify a communication unit configured to perform distance measurement communication with the multiple mobile devices using a predetermined wireless protocol, of each mobile device; acquire data indicating a distance measurement timing for each mobile device; acquire data about a collision timing in which the distance measurement timings of the multiple mobile devices overlap; and at the collision timing, cause the communication unit to perform the distance measurement communication with a high priority device that is the mobile device having the relatively high priority among the two mobile devices having the overlapping distance measurement timing.

### Fifteenth Technical Idea

A control device includes a processor configured to control operations of a communication unit configured to perform distance measurement communication with multiple mobile devices using a predetermined wireless protocol, and causes the processor to: refer to a storage that stores information of the multiple mobile devices that are a position determination target; prioritize the multiple mobile devices that have the information stored in the storage; notify the communication unit of a priority of each mobile device; acquire data indicating a distance measurement timing for each mobile device; acquire data about a collision timing in which the distance measurement timings of the multiple mobile devices overlap; and at the collision timing, cause the communication unit to perform the distance measurement communication with a high priority device that is the mobile device having the relatively high priority among the two mobile devices having the overlapping distance measurement timing.

### Second Note

The various flowcharts presented in the present disclosure are merely examples, and the number of steps constituting the flowcharts or the execution order of the processes can be modified as appropriate. The controls shown in each flowchart may be executed in combination or in parallel as long as there is no contradiction. The expressions such as acquisition, determination, detection, generation, and calculation may be mutually rephrased. Acquisition of certain data by a certain device includes generation of the data based on a signal input from another device/sensor. The communication module may be referred to as a communication chip. The descriptions of wireless signals, data, messages, packets, frames, packages, data sets, and information in the present disclosure may be replaced with each other.

The device, system, and method thereof described in the present disclosure may be implemented by a dedicated computer that constitutes a processor programmed to execute one or multiple functions embodied by a computer program. The device and the method described in the present disclosure may be also implemented by a dedicated hardware logic circuit. Further, the device and the method described in the present disclosure may be also implemented by one or more dedicated computers which are constituted by combinations of a processor for executing computer programs and one or more hardware logic circuits. The processor may be any calculation core such as a CPU, an MPU, a GPU, a DFP (Data Flow Processor), or the like. Some or all of the functions of the position determination device 1 and the anchor 2 may be implemented using any of a system-on-chip (SoC), an integrated circuit (IC), and a field-programmable gate array (FPGA).

The computer program includes instructions executed by the computer. The computer program may be stored in a computer-readable non-transitory tangible storage medium. The storage medium for a computer program may be various media such as a hard disk drive (HDD), a solid state drive (SSD), and a flash memory.

What is claimed is:

1. A distance measurement system comprising:
a communication unit configured to perform distance measurement communication with a plurality of mobile devices using a predetermined wireless protocol; and
a control device including a storage that stores information of the plurality of mobile devices that are a position determination target,
wherein
the control device is configured to
prioritize the plurality of mobile devices, and
notify the communication unit of a priority of each mobile device, and
the communication unit or the control device is configured to
acquire a distance measurement timing that is a timing for performing the distance measurement communication with the plurality of mobile devices, and
determine whether a collision timing is present at which the distance measurement timing of the plurality of mobile devices overlaps, and
the communication unit is configured to perform the distance measurement communication with a high priority device, and
the high priority device is a mobile device having a higher priority than a priority of a different mobile device among the plurality of mobile devices in a state where the distance measurement timing overlaps at the collision timing.

2. The distance measurement system according to claim 1, wherein
the communication unit is configured to
repeat the distance measurement communication with each of the plurality of mobile devices according to a distance measurement interval set for each of the plurality of mobile devices,
apply a setting for performing the distance measurement communication with the high priority device at the collision timing, and
postpone the distance measurement communication with a low priority device that is a mobile device having a lower priority than a different mobile device among the plurality of mobile devices in the state where the distance measurement timing overlaps to a next time determined by the distance measurement interval.

3. The distance measurement system according to claim 1, wherein
the communication unit is configured to
repeat the distance measurement communication with each of the plurality of mobile devices according to a distance measurement interval set for each of the plurality of mobile devices,
determine whether the collision timing is present, and
when determining that the collision timing is present, notify the control device of information of a low priority device that is a mobile device having a lower priority than a priority of a different mobile device among the plurality of mobile devices in the state where the distance measurement timing overlaps, and
the control device is configured to communicate with the low priority device for changing the distance measurement interval with the low priority device.

4. The distance measurement system according to claim 1, wherein
the storage stores data indicating the priority for each mobile device.

5. The distance measurement system according to claim 1, wherein
the control device is configured to determine the priority of each mobile device based on a result of the distance measurement communication.

6. The distance measurement system according to claim 1, wherein
the communication unit is a first communication unit, and
the distance measurement system further includes a second communication unit configured to wirelessly communicate with the plurality of mobile devices by using a wireless protocol different from the wireless protocol supported by the communication unit, and
the control device is configured to
acquire data indicating a reception strength of a signal transmitted by the mobile device from the second communication unit, and
determine the priority for each mobile device based on the reception strength for each mobile device.

7. The distance measurement system according to claim 1, wherein
the control device is configured to set a priority of a mobile device that has not performed the distance measurement communication among the plurality of mobile devices to be lower than a priority of a mobile device that has performed the distance measurement communication.

8. The distance measurement system according to claim 1, wherein
the communication unit or the control device is configured to determine whether the distance measurement timing overlaps based on setting data for the distance measurement communication with the plurality of mobile devices.

9. The distance measurement system according to claim 8, wherein
the setting data includes interval information for defining a distance measurement interval and hopping information for determining an execution timing of the distance measurement communication within a period corresponding to the distance measurement interval.

10. The distance measurement system according to claim 1, wherein
the communication unit is configured to perform the distance measurement communication using ultra wide band communication.

11. A distance measurement method comprising:
causing a control device to store information of a plurality of mobile devices to be a position determination target in a storage;
causing the control device to prioritize the plurality of mobile devices in which the information is stored in the storage;
causing the control device to notify a communication unit, configured to perform distance measurement communication with the plurality of mobile devices using a predetermined wireless protocol, of a priority of each mobile device;
causing the communication unit or the control device to identify a distance measurement timing that is an execution timing of the distance measurement communication for each mobile device;
causing the communication unit or the control device to determine whether a collision timing is present at which the distance measurement timing of the plurality of mobile devices overlaps; and
causing the communication unit to perform the distance measurement communication with a high priority device,
wherein
the high priority device is a mobile device having a higher priority than a priority of a different mobile device among the plurality of mobile devices in a state where the distance measurement timing overlaps at the collision timing.

12. A distance measurement system comprising:
an anchor configured to perform distance measurement communication with a plurality of mobile devices that includes at least one of (i) a first circuit and (ii) a first processor with a first memory storing first computer program code executable by the first processor and uses a predetermined wireless protocol; and
a control device including at least one of (i) a second circuit and (ii) a second processor with a second memory storing second computer program code executable by the second processor, the at least one of the second circuit and the second processor configured to cause the control device to:
store information of the plurality of mobile devices that are a position determination target in a storage
prioritize the plurality of mobile devices, and
provide notification indicating a priority of each mobile device, and the anchor is configured to or the control device is further caused to
acquire a distance measurement timing that is a timing for performing the distance measurement communication with the plurality of mobile devices, and
determine whether a collision timing is present at which the distance measurement timing of the plurality of mobile devices overlaps, and
the anchor is configured to perform the distance measurement communication with a high priority device, and
the high priority device is a mobile device having a higher priority than a priority of a different mobile device among the plurality of mobile devices in a state where the distance measurement timing overlaps at the collision timing.
